(19) United States
(12) Patent Application Publication
(10) Pub. No.: US 2024/0182340 A1
(43) Pub. Date: Jun. 6, 2024

(54) System and Method for Dual-Pathway System for Carbon Dioxide Capture from Ocean Water

(71) Applicant: California Institute of Technology, Pasadena, CA (US)

(72) Inventors: Harry A. Atwater, South Pasadena, CA (US); Chengxiang Xiang, San Marino, CA (US); Ibadillah A. Digdaya, Whittier, CA (US)

(73) Assignee: California Institute of Technology, Pasadena, CA (US)

(21) Appl. No.: 18/061,381

(22) Filed: Dec. 2, 2022

(51) Int. Cl. C02F 9/00; B01D 53/62; B01D 61/44; B01D 61/50; B01D 69/02; B01D 69/08; B01D 69/12; B01D 69/14; B01D 71/26; B01D 71/52; B01J 31/06; B01J 35/06; C01F 11/18

(52) U.S. Cl. CPC C02F 9/00; B01D 53/62; B01D 61/445; B01D 61/50; B01D 69/02; B01D 69/08; B01D 69/1216; B01D 69/144; B01D 69/145; B01D 71/261; B01D 71/262; B01D 71/5211; B01J 31/06; B01J 35/065; C01F 11/181; B01D 2251/304; B01D 2251/604; B01D 2257/504; C02F 2001/007

(57) ABSTRACT

A dual-pathway system for CO₂ capture in both acidified and basified streams is provided. The system may be embodied in an off-shore stand-alone facility to allow for the operation of oceanic CO₂ capture to be more efficient and cost effective. Systems maintain high environmental standards by containing all intermediate acidic and alkaline solutions in a closed system so that the effluent discharged back into the ocean is at the similar pH and salinity as the feed oceanwater, with only CO₂ removed. Acid and base produced by an electrodialyzer unit is used to achieve oceanwater decarbonization via gaseous CO₂ removal and solid CaCO₃ precipitates removal. The system is configured to require the processing of a very small fraction of the total oceanwater intake for the acid-base generation process.

### FEDERAL SUPPORT STATEMENT

This invention was made with government support under Grant No. DE-AR0001407 awarded by the Department of Energy. The government has certain rights in the invention.

### FIELD OF THE INVENTION

Embodiments disclosed herein relate to systems and methods for a dual-pathway system for carbon dioxide capture from ocean water.

### BACKGROUND

Capture and conversion of CO₂ from anthropogenic emission is becoming an increasingly important social responsibility as the concentration of atmospheric CO₂ continues to rise above record high levels. CO₂ from the atmosphere, oceanwater and point sources such as coal fired power plants or cement plants are considered as the major feedstock for subsequent capture and conversion processes. The concentration of the present CO₂ in the atmosphere is ˜400 ppm, or 0.00079 kg m⁻³. As a result, a large volume of air needs to be processed in direct air capture processes. In contrast, world oceans constitutes the largest carbon sink, absorbing about 40% of anthropogenic CO₂ since the beginning of industrial era with an effective CO₂ concentration of 2.1 mmol kg⁻¹, or 0.095 kg m⁻³ in seawater, which is a factor of 120 times larger than in the atmosphere. Thus, extraction of CO₂ from seawater provides an alternative and unique approach in the global carbon removal technological landscape in relative to direct air capture (DAC).

### SUMMARY OF THE INVENTION

Embodiments of the disclosure are directed to systems and methods for a dual-pathway system for carbon dioxide capture from ocean water.

Many embodiments of the disclosure are directed to dual-pathway systems for CO₂ capture including:
a platform disposed adjacent a source of oceanwater;
an acid-base-generator in fluid communication with the source of oceanwater including:
   a purification apparatus configured to convert a first portion of the oceanwater into a feedstock of NaCl, and
   at least one electrodialyzer in fluid communication with the purification apparatus and incorporated a bipolar membrane configured to convert the feedstock of NaCl into a HCl feedstock and a NaOH feedstock;
an acidic CO₂ removal system in fluid communication with the source of oceanwater including:
   an acidification element in fluid communication with the HCl feedstock and configured to produce an acidified oceanwater feedstock from the oceanwater, and
   a catalyst-bonded membrane contactor in fluid communication with the acidification element and a vacuum system to extract gaseous CO₂ from the acidified oceanwater feedstock and output a decarbonized acidified oceanwater effluent to an output;
an alkaline CO₂ removal system in fluid communication with a source of fluid entrained CO₂ and in further fluid communication with the NaOH feedstock and configured to produce a CO₂ lean effluent and a carbonate; and
wherein the output mixes the decarbonized acidified oceanwater effluent and at least one effluent from the alkaline CO₂ removal system to form a mixed oceanwater effluent for release into the environment.

In still many embodiments of the disclosure the alkaline CO₂ removal system is in fluid communication with the source of oceanwater and includes:
a basification element in fluid communication with the NaOH feedstock and configured to produce a basified oceanwater feedstock from the oceanwater, and
a sedimentation element in fluid communication with the basification element to collect mineral carbonate precipitates from the basified oceanwater feedstock and output a decarbonized basified oceanwater effluent to the output; and
wherein the output mixes the decarbonized acidified oceanwater effluent and the decarbonized basified oceanwater effluent to form a mixed oceanwater effluent having a pH approximately equivalent to the pH of the source of oceanwater for release into the environment.

In yet many embodiments of the disclosure the alkaline CO₂ removal system is in fluid communication with the fluid entrained CO₂, which comprises a source of CO₂ containing gas feedstock and includes:
a direct air capture element in fluid communication with the NaOH feedstock and the CO₂ containing gas feedstock configured to produce a CO₂-lean gas effluent and a carbonate solution; and
wherein the output mixes the decarbonized acidified oceanwater effluent and the carbonate solution to entrain the CO₂ within the carbonate into the decarbonized acidified oceanwater effluent for release into the environment.

In still yet many embodiments of the disclosure the acidified oceanwater feedstock has a pH range between pH˜4 to pH˜7.

In yet still many embodiments of the disclosure the basified oceanwater feedstock has a pH of around 10, and wherein the mineral carbonate is CaCO₃.

In still yet many embodiments of the disclosure the oceanwater and mixed oceanwater effluent have a pH of around 8.

In yet still many embodiments of the disclosure the system includes at least one pre-processing element disposed between the source of oceanwater and the acid-base generator, the acidic CO₂ removal system and the alkaline CO₂ removal system to screen the oceanwater.

In still yet many embodiments of the disclosure the pre-processing element comprises a drum-screen filter.

In yet still many embodiments of the disclosure the purification apparatus comprises one or more of the elements selected from the group consisting of dissolved air flotation clarifiers, micro/ultra-filters, cartridge filters, and water softening ion exchangers.

In still yet many embodiments of the disclosure the purification apparatus comprises at least a clarifier and an ion exchanger, and wherein the clarifier is in fluid communication with the HCl feedstock and the ion exchange is in fluid communicate with the NaOH feedstock.

In yet still many embodiments of the disclosure the electrodialyzer is configures to operate at a current density between 250 mA/cm² to 1000 mA/cm².

In still yet many embodiments of the disclosure the bipolar membrane comprises a catalyzed ionic layer bound directly onto one of either a cationic-exchange membrane or an anionic-exchange membrane.

In yet still many embodiments of the disclosure the ionic layer has a thickness between 5-50 μm.

In still yet many embodiments of the disclosure the bipolar membrane is a trilayer structure comprising at least three elements selected from the group consisting of porous solid electrolytes, cationic-exchange membranes, and anionic-exchange membranes.

In yet still many embodiments of the disclosure the catalyzed ionic layer comprises at least one buffering group with a pKₐ of approximately 7.

In still yet many embodiments of the disclosure the catalyzed ionic layer comprises at least one buffering group covalently bound to a polymer backbone.

In yet still many embodiments of the disclosure the polymer backbone is selected from the group consisting of polyethylene oxide, polypropylene and polyethylene.

In still yet many embodiments of the disclosure the at least one buffering group is selected from the group consisting of phosphonates and metal-oxide nanomaterials.

In yet still many embodiments of the disclosure the system includes a stack of electrodialyzers.

In still yet many embodiments of the disclosure the catalyst-bonded membrane contactor comprises one or more gas-liquid membrane contactor materials having bonded thereto a buffering group catalyst.

In yet still many embodiments of the disclosure the gas-liquid membrane contactor material comprises one or more hollow-fiber.

In still yet many embodiments of the disclosure the one or more hollow-fiber is a material selected from the group consisting of polypropylene or polyethylene.

In yet still many embodiments of the disclosure the buffering group catalyst is a synthetic carbon anhydrase mimic.

In still yet many embodiments of the disclosure the catalyst-bonded membrane contactor comprises a baffle structure disposed exterior to the one or more hollow-fiber such that flows of the acidified oceanwater feedstock are introduced at one or more angles to the one or more hollow-fiber.

In yet still many embodiments of the disclosure at least a portion of the catalyst-bonded membrane contactor proximal to an intake thereof is free of the buffering group catalyst.

In still yet many embodiments of the disclosure the system includes one or more renewable power sources electrically interconnected to power the dual-path system.

In yet still many embodiments of the disclosure at least one of the renewable power sources if photovoltaics and wherein the photovoltaics collect infrared radiation, and wherein the infrared radiation is used to generate heat to heat the catalyst-bonded membrane contactor.

In still yet many embodiments of the disclosure the sedimentation element is further provided with at least one seeding growth material selected from the group consisting of vaterite, calcite, and salt solutions thereof.

In yet still many embodiments of the disclosure the first portion comprises ˜0.5% of the oceanwater introduced into the dual-pathway system.

In still yet many embodiments of the disclosure the catalyst-bonded membrane contactor is in fluid communication with the HCl feedstock.

In yet still many embodiments of the disclosure at least one electrodialyzer further outputs a dilute low salt concentration water effluent, and wherein the dilute low salt concentration water effluent is reintroduced into the electrodialyzer as a feedstock.

Various embodiments of the disclosure are directed to dual-pathway methods for CO₂ capture including:
introducing a first portion of oceanwater into an acid-base-generator;
converting the first portion of the oceanwater into a feedstock of NaCl;
electrodialyzing in a bipolar membrane the NaCl into a HCl feedstock and a NaOH feedstock;
introducing a second portion of oceanwater to an acidification element in fluid communication with the HCl feedstock to produce an acidified oceanwater feedstock from the oceanwater;
extracting gaseous CO₂ from the acidified oceanwater feedstock through a catalyst-bonded membrane contactor and outputting a decarbonized acidified oceanwater effluent;
introducing a source of fluid entrained CO₂ to an alkaline CO₂ removal system in fluid communication with the NaOH feedstock and configured to produce a CO₂ lean effluent and a carbonate; and
mixing the decarbonized acidified oceanwater effluent and at least one effluent from the alkaline CO₂ removal system to form a mixed oceanwater effluent for release into the environment.

In still various embodiments of the disclosure the source of fluid entrained CO₂ comprises a third portion of oceanwater, and further including:
introducing the third portion to a basification element in fluid communication with the NaOH feedstock to produce a basified oceanwater feedstock from the oceanwater;
collecting a mineral carbonate precipitate from the basified oceanwater feedstock and outputting a decarbonized basified oceanwater effluent; and
mixing the decarbonized acidified oceanwater effluent and the decarbonized basified oceanwater effluent to form a mixed oceanwater effluent having a pH approximately equivalent to the pH of the source of oceanwater for release into the environment.

In yet various embodiments of the disclosure the source of fluid entrained CO₂ comprises a CO₂ containing gas feedstock, and further including:
introducing the CO₂ containing gas feedstock to a direct air capture element in fluid communication with the NaOH feedstock and configured to produce a CO₂-lean gas effluent and a carbonate solution; and
wherein the output mixes the decarbonized acidified oceanwater effluent and the carbonate solution to entrain the CO₂ within the carbonate into the decarbonized acidified oceanwater effluent for release into the environment.

In still yet various embodiments of the disclosure the acidified oceanwater feedstock has a pH range between pH˜4 to pH˜7.

In yet still various embodiments of the disclosure the basified oceanwater feedstock has a pH of around 10, and wherein the mineral carbonate precipitate is CaCO₃.

In still yet various embodiments of the disclosure the first portion comprises ˜0.5% of the oceanwater introduced into the dual-pathway system.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1a provides a schematic illustration of a hybrid CO₂ capture system via electrochemical pH according to aspects of the disclosure;

FIG. 1b provides a schematic illustration of a hybrid CO₂ capture system via electrochemical pH incorporating a direct air capture system according to aspects of the disclosure;

FIG. 1c provides data plots of the effect of regeneration on CO₂ extraction efficiency in the gas liquid contactors according to aspects of the disclosure;

FIG. 2a provides a schematic illustration of an acidic pathway portion of an oceanic CO₂ removal system according to aspects of the disclosure;

FIG. 2b provides a schematic illustration of an electrodialysis with bipolar membranes process according to the prior art.

FIG. 3a provides a data plot of high current density from a BPM in 0.5 M NaCl (aq) according to the prior art;

FIG. 3b provides a data plot showing >0.5 A cm-2 from a BPM with ˜10 μm thick AEM in 1 M KCl (aq.) according to aspects of the disclosure;

FIG. 4 provides a schematic Illustration of a BPM structure with a thin cationic layer, and a BPM with a tri-layer structure according to aspects of the disclosure;

FIG. 5a provides numerical modeling results at pH 7 for 0.5 M of each of two buffering groups (two pKₐ values) indicating current densities for WDF at zero bias are largest (50 mA/cm²) for one buffer with pKₐ=7 (dashed line) or several combinations of two buffers (lightest colors) according to aspects of the disclosure;

FIG. 5b provides a plot of experimental data for a series of novel tri-layer BPMs with PPO-Pᵢ middle layer (pKₐ≈7) when separating 0.5 M salt solutions illustrating that at low overpotential (<0.4 V) BPMs according to aspects of the disclosure (circles) outperform state-of-the-art commercial Fumatech FBM and graphene oxide (open squares).

FIG. 6a provides a schematic of catalyst-bonded membranes in a gas-liquid contactor according to aspects of the disclosure;

FIG. 6b provides a plot of modeling results for attainable CO₂ removal rates at different pH values for the acidified oceanwater, which in the absence of any acidification has pH≈8.1 according to aspects of the disclosure;

FIG. 7 provides mass spectrometry data for CO₂ (m/z=44) before and after addition of sodium phosphate WDF/BDF catalysts to NaHCO₃ solution (pH 7), according to aspects of the disclosure;

FIG. 8 provides a table of the concentration of major constituents of major constituents of natural seawater in accordance with the prior art; and

FIG. 9 provides a schematic illustration of an apparatus to characterize the precipitation rates and particle sizes in the basified stream according to aspects of the disclosure.

### DETAILED DESCRIPTION

It will be readily understood that the components of the embodiments as generally described herein and illustrated in the appended figures may be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

Aspects of the instant disclosure are directed to a dual-pathway system for CO₂ capture from oceanwater. Various aspects contemplate applications of such a system in an off-shore stand-alone facility to allow for the operation of oceanic CO₂ capture to be more efficient and cost effective. Aspects of the system minimize oceanwater intake costs by use of an off-shore, floating platform that intake oceanwater directly. In many aspects systems will maintain high environmental standards by containing all intermediate acidic and alkaline solutions in a closed system so that the effluent discharged back into the ocean is at a mild pH and the same salinity as the feed oceanwater, with only CO₂ removed. Aspects also include the combined use of acid and base produced by the electrodialyzer unit to achieve oceanwater decarbonization via gaseous CO₂ removal and solid CaCO₃ precipitates removal. According to aspects the system may be configured to require the processing of a very small fraction of the total processed oceanwater for the acid-base generation process. Aspects contemplate that dual-pathway systems in which CO₂ is captured from oceanwater in both the acidified and basified streams, lower the total cost for negative CO₂ emission at scale.

Traditional oceanwater capture involves pushing a CO₂/bicarbonate equilibrium toward dissolved CO₂ by acidifying the oceanwater via electrodialysis. The acidified stream is then passed through a liquid-gas membrane contactor, which captures the gaseous CO₂ from the dissolved CO₂ in the aqueous stream. These conventional oceanwater capture systems include challenges including: oceanwater intake and pretreatment costs; and the minimal co-location opportunities.

For land-based oceanic CO₂ removal systems oceanwater intake and pre-treatment dominate the cost. Based on the current and projected costs in desalination plants, the ocean intake, pretreatment and discharge for a land-based stand-alone CO₂ capture plant cost about $1.4M/million gallon-day, which translates to a best-case cost of $1839/t-CO₂. While these costs could be reduced as the technology scales, it is nearly impossible to meet the realistic cost target of <$100/t-CO₂ in the long term using such an approach. Decreasing the long distances for oceanwater intake, transport, and pre-treatment is critical to reduced cost of oceanic CO₂ removal.

With respect to desalination, the co-location of oceanic CO₂ removal systems with desalination plants is not considered to be scalable. While co-location of oceanic CO₂ removal systems with desalination plants overcomes the issue of distance, technoeconomic analyses suggest that this results in a system for oceanic CO₂ removal ($373/t-CO₂) with a best-case cost that is still far from the FOA target of <$100/t-CO₂. Moreover, even for the unrealistic scenario where reverse osmosis plants produce all potable water currently consumed worldwide (4.3 trillion m³/yr) and all CO₂ is removed from that water, only 0.95 Gt-CO₂/yr is possible, meaning that co-location of oceanic CO₂ removal systems with desalination plants does not provide a viable path for scaleup to the cost target of >1 Gt-CO₂/yr.

Aspects of the disclosure provide a ‘dual-pathway’ CO₂ capture system that generates both acidified and alkaline water streams via an electrochemical pH swing. The system implements CO₂ capture in both an alkaline pathway where dissolved inorganic carbon is pushed towards CaCO₃ formation, as well as in a gaseous CO₂ capture using an electrodialyzer at high current densities from the acidified stream. Accordingly, aspects of alkaline systems are directed to methods and systems for controlling CaCO₃ precipitation kinetics in the basified oceanwater stream to enhance the calcite (solid phase CaCO₃) formation via control of pH, temperature, and crystallization kinetics in the calcite growth. Aspects of acidified systems incorporate a fast redox couple electrolyte in a unique electrodialysis architecture for oceanic CO₂ removal that incorporates single cell voltage and the lowest required electrochemical energy for electrodialysis. Aspects of the electrodialyzer design provide for gaseous CO₂ capture at high current densities from the acidified stream. Accordingly, dual-pathway systems combine basified and acidified aspects for CO₂ capture using the alkaline electrolyte produced in the basified stream via CaCO₃ formation to increase the overall CO₂ capture efficiency.

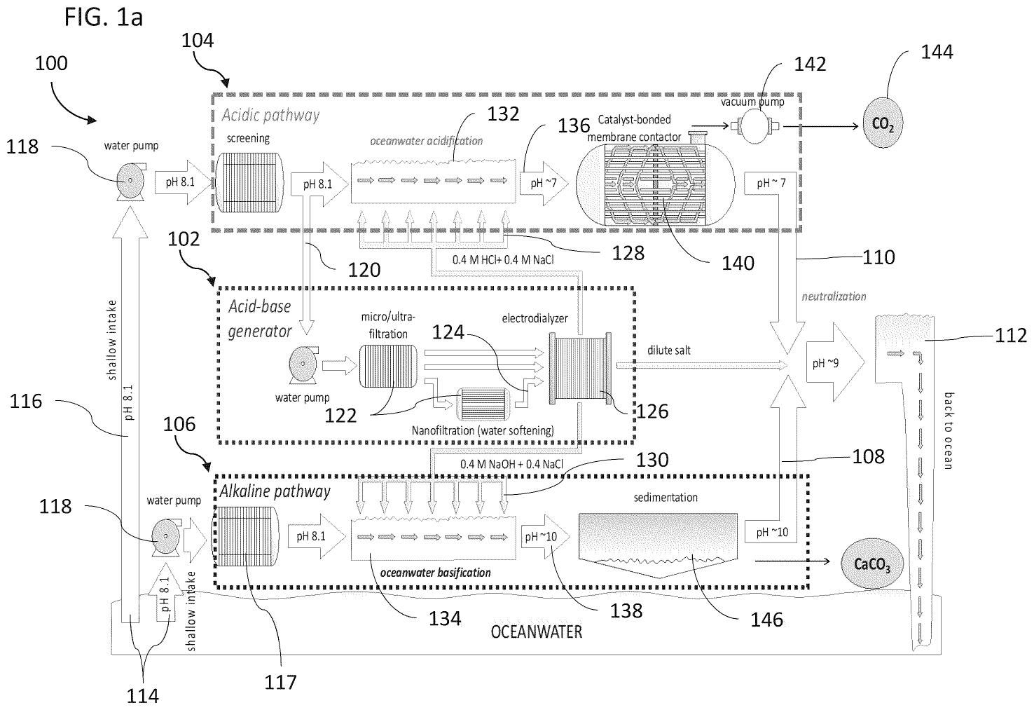

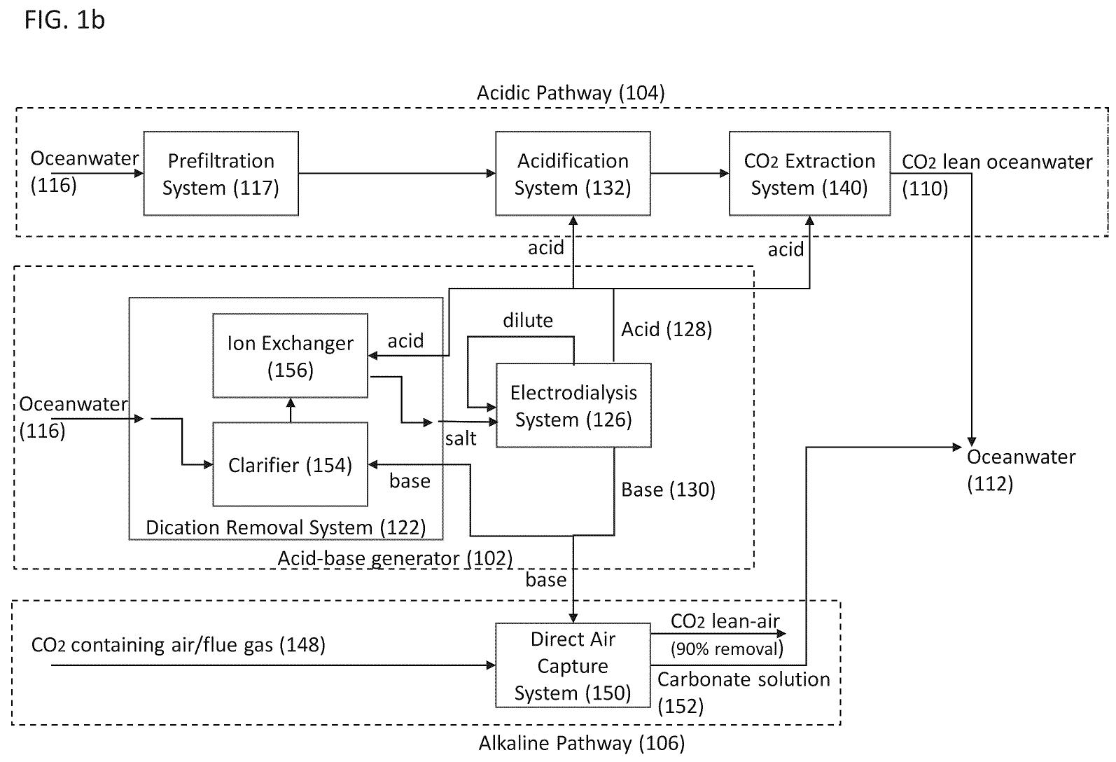

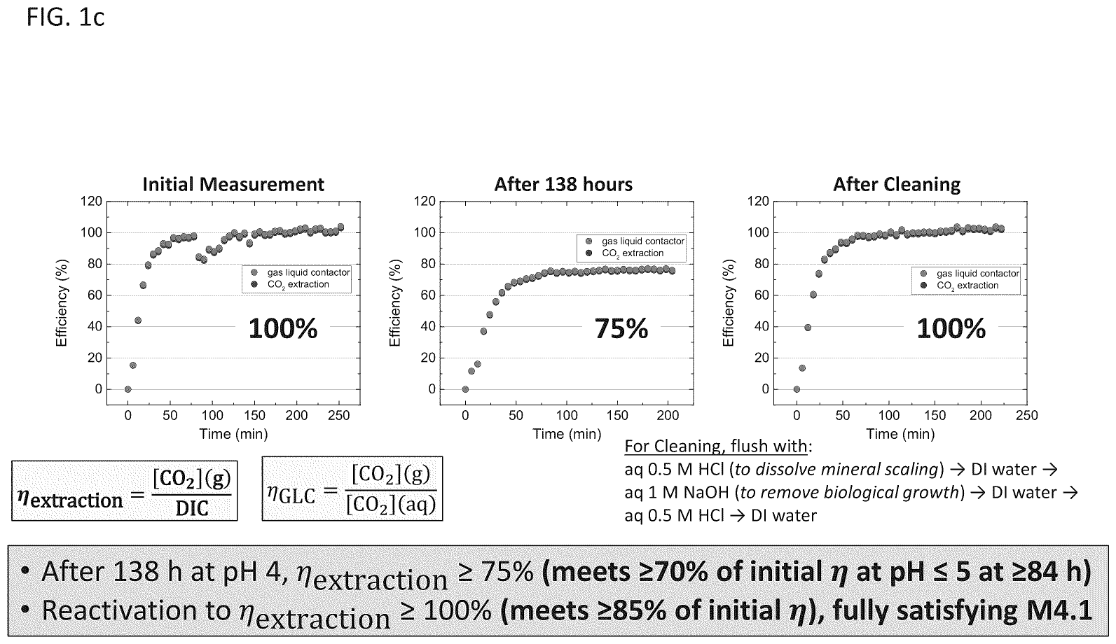

As shown in FIG. 1a, aspects of dual-pathway systems and methods consist of a modular on-water, stand-alone system for oceanic CO₂ removal. In various aspects, hybrid oceanic CO₂ capture systems (100) comprise, among other things three main components, an acid-base generator (102), an acidified pathway (104) for generation of gaseous CO₂, and an alkaline pathway (106) for generation of CaCO₃. As shown, the acid (108) and alkaline (110) streams are then recombined and the decarbonized oceanwater (112) released back to the ocean at a balanced pH. Each of these system aspects, their integration, and related process methods will be discussed in greater detail below. Aspects of the systems are directed to minimizing oceanwater intake costs by use of an off-shore, stand-alone design, and maintain high environmental standards by containing all intermediate acidic and alkaline solutions in a closed system so that the effluent discharged back into the ocean is at a similar pH and and the same salinity as the feed oceanwater, with only CO₂ removed.

Accordingly, aspects of the dual-pathway system include an overall floating platform located in a saltwater body such as the ocean allowing for the vast majority of the processed oceanwater to be pumped only a short vertical distance from underneath the floating platform. In such aspects one or more intakes (114) are provided that are configured to feed untreated seawater (116) into the acidified pathway and the alkaline pathway. As shown, the intakes may include pre-processing (117) aspects including, for example, screens or other filters to prevent unwanted contaminants from entering the CO₂ extraction pathway. The intakes, pre-processing systems, pumps (118) to bring the water into the system and the overall dimensions and construction of the floating platform may take any suitable configuration capable of supporting and providing oceanwater to the dual-pathway system. In aspects stable continuous operation of a dual-pathways system (e.g., 84 h at 70% of initial CO₂ removal rate) may be accomplished with feed water consisting of only drum-screen-filtered oceanwater at the typical CO₂ removal pH (pH≤5), and subsequent reactivation to 95% of initial CO₂ removal rate. Accordingly, in various aspects of the dual-pathway system inexpensive filtration methods are sufficient to enable robust operation with minimal fouling that can be regenerated for long lifetime operation without requiring expansive and expensive water pre-treatment.

One significant advantage of such a floating pathway is the short distance (e.g., a few meters) that the system is required to move the untreated water. Decreasing the long distances for oceanwater intake, transport, and pre-treatment is one aspect of the disclosed systems that allows for reduced cost of oceanic CO₂ removal. As previously discussed, oceanwater intake and pre-treatment dominate the cost of land-based oceanic CO₂ removal systems a co-location of desalination plants is not sufficiently scalable such that it is nearly impossible to meet the target of <$100/t-CO₂ in the long term using such an approach.

In various aspects incoming oceanwater is directed to one of three pathways in the dual-pathway system: an acidic pathway (104), an alkaline pathway (106) and an acid-base generator (102). Aspects and elements of each of these pathways will be described in greater detail, however, it should be understood that these pathways are exemplary and each may include additional treatment or conditioning elements to improve the process.

Aspects of the acidic pathway (104) decarbonizes feed oceanwater by “pushing” and “pulling” CO₂ from bicarbonate via the following reactions:

HCO₃⁻(aq)⇄OH⁻(aq)+CO₂(aq)+H⁺(aq)⇄H₂O(I)+CO₂(aq)⇄CO₂(g) (EQ. 1)

In such aspects, to progress the reaction in the forward direction, an increased concentration of H⁺ “pushes” the reaction to form water by mass action and a decreased p_{CO2} “pulls” the reaction to form gaseous CO₂ by Le Chatelier's principle. Similarly, aspects of the alkaline pathway (106) decarbonizes feed oceanwater by using the same “pushing” and “pulling” from basified oceanwater for the generation of precipitation products, including CaCO₃, Ca(OH)₂, MgCO₃, Mg(OH)₂, SrSO₄, CaF₂ and CaSO₄. It will be noted that while not all of these precipitation products contribute equivalently to CO₂ capture (such as, for example precipitation products Mg(OH)₂) they can be used for other applications such as cement making, etc. and as a valuable by-product in the process to lower the operation cost of the overall system.

Aspects of the dual-pathway system and method efficiently push these reactions forward by directing a fraction (120) of the total processed oceanwater through an acid-base-generator (102) where a multi-stage pre-treatment process (122) produces a purified stream of salt (e.g., NaCl (124)) that is fed to a high current density, low voltage electrodialyzer (126) for generation of HCl and NaOH, which are then fed (128/130) into the acidification (132) and basification (134) elements of the acidic and alkaline pathways. These acidified (136) and basified (138) water feedstocks are then directed to the related CO₂ extraction element for the relevant pathway. In the acidic pathway this extraction element comprises a catalyst-bonded membrane contactor (140) and a suitable vacuum pump (142) for exhausting the gaseous CO₂ (144). In the alkaline pathway this extraction element comprises a suitable sedimentation element (146) and any other apparatus necessary for the extraction of the precipitate.

Although, an implementation of a dual-pathway system configured to process multiple streams of oceanwater has been discussed with reference to FIG. 1a, it will be understood that other configurations may be implemented that incorporate mixed feedstock streams. As shown in FIG. 1b, in various aspects of the dual-pathway system may incorporated many of the same systems previously described (e.g., an acid-base generator (102) and acid pathway (104) as described in FIG. 1a), but instead incorporate gas feedstocks (148) containing streams of CO₂. In various such aspects the gas feedstocks may include any suitable source of gas entrained with sufficient concentrations of CO₂ (e.g., >400 ppm), including, for example, atmospheric air or industrial waste or flue gases. Aspects incorporating gas extraction systems may incorporate any suitable direct air capture system (150). Although many such direct air capture systems may be incorporated, in various aspects the direct air capture system uses an aqueous basic solution (130) produced and provided to the direct air capture system from the acid-base generator (102) to forms CO₂ lean gas streams and effluents of carbonate solutions (152)(e.g., NaCO₃ solution), which can then be reintroduced into the CO₂ lean water effluent (110) from the acidic pathway to release and entrain the CO₂ into the output oceanwater (112).

As also shown in FIG. 1b, various aspects of the system incorporate system regeneration pathways. For example, it will be understood that the catalyst-bonded contactor membrane (140) of the acidic pathway, and the pre-treatment elements (e.g., clarifier (154) and ion exchanger (156)) may become fouled over time. In conventional systems, regeneration acids and bases must be supplied on a periodic basis to these systems to clean them, however, this requires regular resupply of the platform. In various aspects of the dual-pathway system these regenerative acids and bases may be supplied directly from the acid-base generator (102) thereby allowing for the self-contained maintenance of platform elements. In various such aspects, for example, a stream of acid may be provided to the CO₂ extractor element of the acidic pathway to regenerate the catalyzed contactor membrane element. Similarly, in various aspects, a base stream may be provided as the feedstock for the clarifier to precipitate out dications (for example, Mg²⁺ or Ca²⁺) in the oceanwater into hydroxides or carbonates, and a acid stream may be provided to regenerate the resins used in the ion exchange step to achieve efficient and effective dication removals down to <1 ppm level as the feed solution for the electrodialysis system. FIG. 1c, provides a set of data plots showing the effect of regeneration on efficiency of CO₂ extraction in the system. As shown, using acid and base streams from the electrodialyzer it is possible to regenerate the CO₂ efficiency of the system back to starting levels thereby allowing a greater duty-cycle for the overall dual-pathway system.

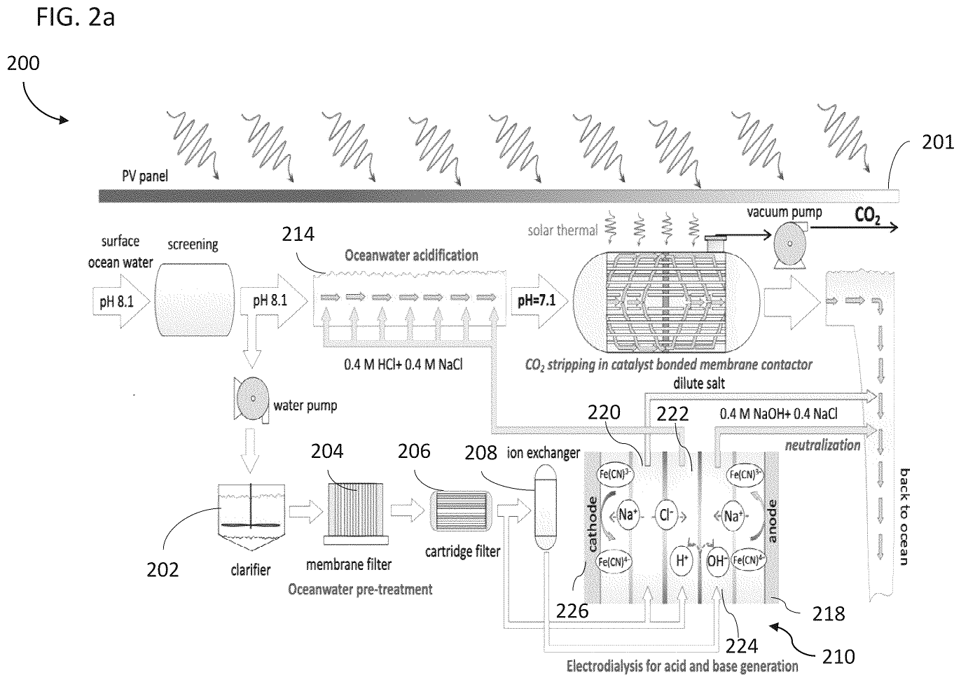

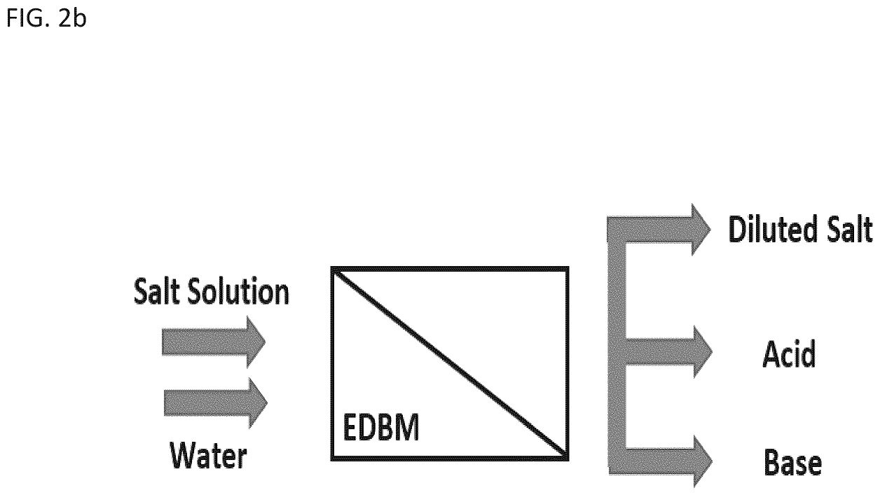

Although the above discussion has focused on a several aspects of a dual-pathway system and methods according to the disclosure it will be understood that other aspects and elements may be incorporated as necessary or advantageous to the operation of the system and methods. For example, as shown in FIG. 2a, in various embodiments the platform (200) can receive power for running the various elements of the system and method using large area commercial floating array of solar panels (201) or other renewable or grid-assisted-renewable sources, such as off-shore wind, along with energy storage systems to achieve a sufficient capacity factor (e.g., 90% or higher) for the system.

Detailed discussions of aspects of the acid-base generator, acidic pathway and alkaline pathway are provided in the sections below and are to be read as incorporating each and every aspect and elements described in the above sections as well as in the sections to follow.

### Aspects of Acid-Base-Generator Electrodialyzer

Aspects of the dual-pathway system and methods require a low-overpotential electrodialyzer operating at between 250 mA/cm² to >1000 mA/cm², a system currently unavailable in the art. Turning to the details of the acid-base-generator (102), it will be understood that a small amount of the inflow of water is diverted to a pre-treatment element (122) in the acid-base-generator (102). Although in FIG. 1a the inflow of water is shown as originating from the acidic pathway, it will be understood that incoming water from either pathway, a combination of pathways or a separate source (as shown in FIG. 1b) may be used. According to various aspects, the pre-treatment element may include any components suitable to convert the screened oceanwater into a purified stream of NaCl for use in the electrodialyzer (126) to produce streams of HCl (between 0.8M to 2.5 M) and NaOH (between 0.8M to 2.5 M) for the acidic and alkaline pathways. As shown in greater detail in FIGS. 1b and 2a, pre-treatment elements may include, dissolved air flotation clarifiers (202), micro/ultra-filters (204), cartridge filter (206), and water softening (ion exchanger) (208), among other elements. Regardless of the arrangement of specific elements in aspects a salt-splitting process is configured to provide a purified stream of NaCl and H₂O to the electrodialyzer (210). The electrodialyzer then dissociates the water stream using a bipolar membrane to form OH⁻ and H⁺ ions that are recombined with the Na⁺ and Cl⁻ ions to form HCl (between 0.8M to 2.5 M) and NaOH (between 0.8M to 2.5 M) that are used introduced into the acidifier (214) and the basifier (not shown) to drive the CO₂ recovery reactions in the acidic and alkaline pathways.

FIGS. 1a/1b and 2a are show as producing an output of acid and base that can be used to run various aspects of the overall dual-pathway system. These systems also produce a stream of dilute solution with low salt concentration (between 0.01 to 0.1 M) after electrodialysis process (e.g., dilute). Although this dilute is shown as an effluent that is output with the rest of the effluent stream into the ocean, in various aspects (as shown in FIG. 1b) this dilute (which has already been purified by the pre-processing system (122) of the acid-base generator (102)), may be reintroduced into the electrodialyzer thus further reducing the overall volume of oceanwater that needs to be processed through the system.

In various aspects, as shown in FIG. 2a, a single cell of an electrodialyzer in accordance with the disclosure may have a suitable active surface area for electrodialysis of purified oceanwater at between 250 mA/cm² to >1000 mA/cm². In such aspects each cell of the electrodialyzer may consist of an anode compartment (218), dilute salt compartment (220), acid compartment (222), base compartment (224) and cathode compartment (226). Conductive plates (e.g., Pt-coated Ti plates) may be used as the cathode and the anode and a solution containing one-electron electrochemically reversible redox couple may be used as the anolyte and the catholyte. The thickness and spacing of membranes, as well as redox couple type and concentration may be varied to achieve a target voltage in the system (e.g., 1.6 V).

The basic aspect of electrodialysis with bipolar membranes (EDBM) is the combination of electrodialysis for salt separation with electrodialysis water splitting for the conversion of a salt into its corresponding acid and base. The bipolar membranes enhance the splitting of water into protons and hydroxide ions. This is shown schematically in FIG. 2b. Bipolar membranes are a special type of layered ion exchange (IX) membrane where the two polymer layers one is only permeable for the anions and the other only for cations. Unlike membrane processes EBM isn't applied for separation purposes but to get a reaction in the bipolar junction of the membrane where the anion and the cation permeable layers are in direct contact. Water splits into hydroxide ions and protons. The produced hydroxide ion and proton are separated by migration in the respective membrane layer out of the membrane.

₂H₂O↔H₃O++OH— (EQ. 2)

Unlike water splitting at electrodes during electrolysis, no gases are formed as a side product to this reaction, nor are gases used. Electrodialysis with bipolar membranes (EDBM) can replace electrolysis with water splitting at the electrodes and can also have a wider variety of applications.

Despite the apparent advantages of EDBM systems, conventional salt-splitting technologies, such as those proposed for use in the acid-base-generator of the disclosure have a number of issues, the first of which is that electrodialyzers to produce acid/base are generally very expensive to run and maintain. Currently, the main drivers of the high cost of electrodialyzers are the high cost of membrane materials and the efficiency of water dissociation at the bipolar membrane (BPM) interface. Inefficient rates of water dissociation necessitate high operating voltage (>1.3 V/cell) while diffusional mass transport limits for water to the BPM interface result in low operating current density (<200 mA cm²). According to aspects of the dual-path system according to the instant disclosure, acid-base-generators are demonstrated incorporating low-overpotential electrodialyzers that operate at high current densities (between 250 mA/cm² to >1000 mA/cm²). Significantly lowering the overpotentials and increasing the current densities diminish the size of the electrodialyzer, thus lowering overall system cost, and particularly the high associated costs for producing acidic and basic solutions required to push the CO₂ release reactions in the acidic and alkaline pathways of the dual-pathway system.

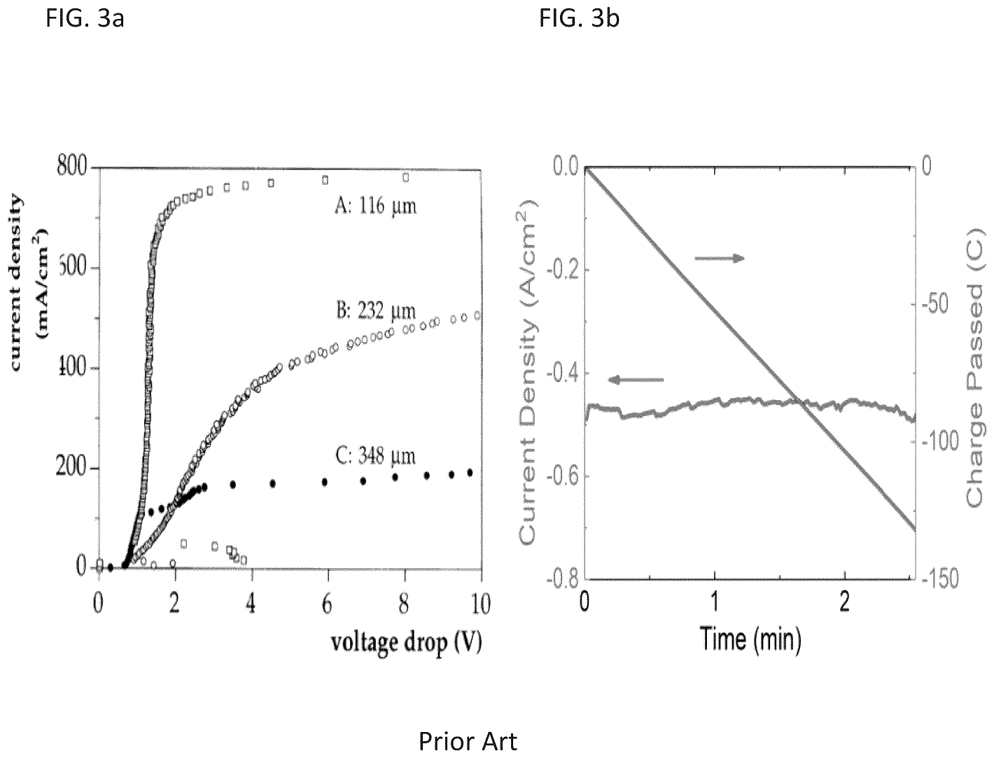

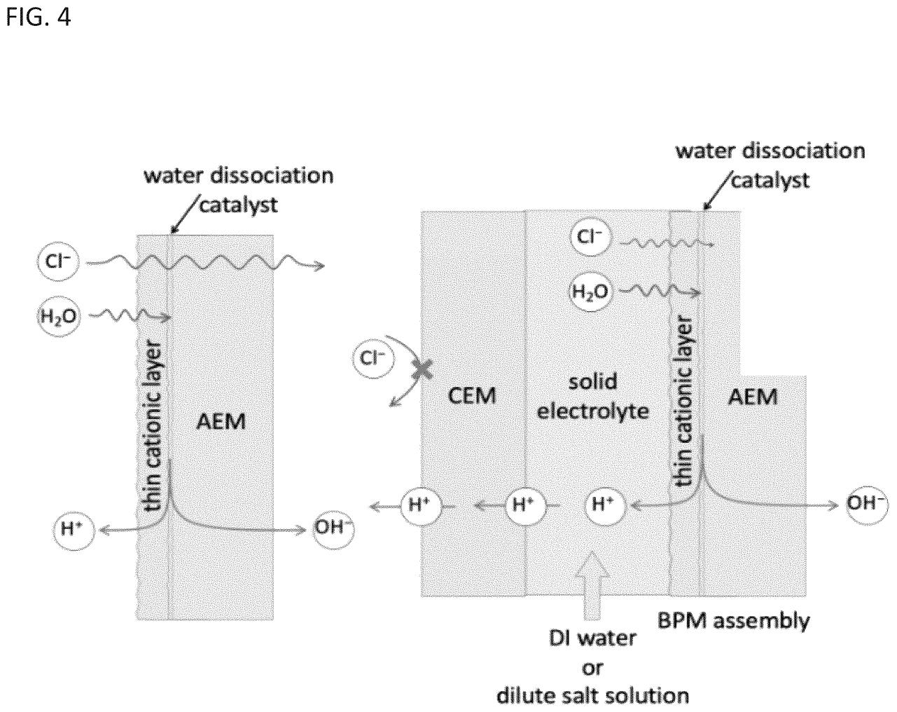

Aspects of the dual-pathway system and method implement tailored BPM materials to increase the operating current density from typical values of ˜100 mA cm² to between 250 mA/cm² to >1000 mA/cm². Limiting BPM current densities may arise from dehydration of the BPM interface during high rates of water dissociation (WD). Studies have shown that thinner membranes can mitigate this dehydration. As shown in FIG. 3a, an operating current density of ˜800 mA cm² was reported for a 116 μm thick membrane, and data using a ˜60 μm thick BPM with a thin AEM layer (˜10 μm) achieved >500 mA cm² (FIG. 3b). Accordingly, in various aspects of low-overpotential/high current density electrodialyzers according to the disclosure, BPMs containing covalently bound catalysts are provided to increase the reversible rate of water dissociation and formation (WDF: H₂O⇄H⁺(aq)+OH⁻(aq)). In such electrodialyzers, membrane-bound WDF catalysts within the BPM lower the electrodialyzer operating voltage by increasing the WDF reaction exchange rate. In various aspects a thin cationic (or anionic) layer (5-50 μm) may be synthesized and bound directly onto a robust commercial cationic-exchange membrane CEM (or anionic-exchange membrane AEM) to further improve water transport to the BPM interface to achieve between 250 mA/cm² to >1000 mA/cm². Thin membrane layers do have the potential to cause increased co-ion crossover, thus lowering electrodialysis efficiency. Accordingly, in aspects tri-layer BPM architectures are implemented to prevent dehydration at BPM interfaces. Specifically, tri-layer BPMs (FIG. 4) may be provided such that co-ion crossover is minimized, and active water feed from dilute salt may be used to hydrate the BPM interface. Results of studies conducted on electrochemical architectures have successfully demonstrate H₂O₂ generation and CO₂ reduction at high rates. Such BPMs enable operating current densities of between 250 mA/cm² to >1000 mA/cm², instead of the typical ˜200 mA cm² when limited by water transport to the BPM junction.

Turning to specific materials and configurations of BPMs contemplated for dual-path systems according to the disclosure, in various aspects BPMs incorporating a thin anionic (cationic) layer may include materials such as, for example, X37 or XA9 ionomer (e.g., Nafion or sulfonated polyphenyl sulfone). Such BPMS may be attached, for example, to <50 μm thick commercial CEMs (AEMs). As discussed, one potential risk is increased ionic crossover due to the potential low selectivity of the casted thin layer, which will lower the efficiency of the electrodialyzer. In various aspects tri-layer BPM structures may integrate a porous solid electrolyte, such as, for example, a polymer ion conductor or solidified gel, as shown in FIG. 4. Such a porous solid electrolyte may then be infiltrated, via flow, with dilute salt or deionized water. It will be understood that in such aspects, commercially available CEMs and AEMs with a thickness of ˜50-100 μm used in the BPM structure will ensure low crossover rates, while an active water feed at the BPM interface may be implemented to circumvent water loss. In various implementations, styrene-divinylbenzene copolymer microspheres functionalized with sulfonic acid groups for cation (H⁺) conduction may be integrated at the BPM interface. In such aspects the interconnected surface provides for rapid ionic conduction, while micrometer-scale pores allow sufficient hydration for high current density operation.

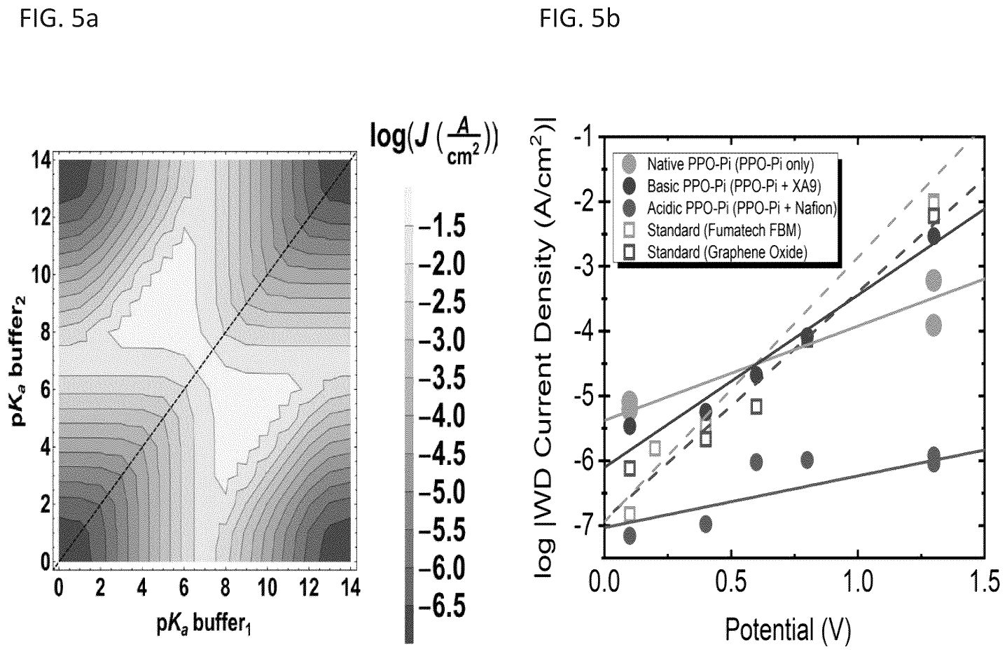

As previously discussed in addition to high current density, aspects of electrodialyzers according to the disclosure are directed to bipolar membranes for low voltage operation. In developing such low voltage electrodialyzers aspects of the disclosure consider the electrostatics, chemical reactions, and migration and diffusion of solution species that are critical to achieve high WDF catalysis rates at the BPM interface, and to couple electric-field-enhanced WD for an additional driving force for ion transport to the BPM interface. As observed in previous experiments and computations, buffering groups with pKₐ=7 and local pH=7 result in the most rapid rates of chemically catalyzed WDF. This is described by the Shockley-Read-Hall mechanism for the most rapid rate of generation and recombination of mobile charges, where half-filled midgap states maximize this rates: pKₐ=pH=0.5×(pKₐ(H₂O(I))+pKₐ(H*(aq)))=7. Aspects of the disclosure recognize some flexibility may be achieved in desired pKₐ values by using two buffering groups (FIG. 5a). These maximum current densities are for experimentally possible concentrations of 1 M buffering groups and may, be further enhanced by the local electric fields inherent when pH gradients exist across the BPM. For tri-layer designs, such as those described above, that better facilitate water transport, the pH gradients and electric fields are necessarily smaller, necessitating effective chemical catalysis of WDF.

Accordingly, in various aspects of low-overpotential/high current density electrodialyzers according to the disclosure, modified BPM polymers are implemented that contain buffering groups with pKₐ≈7, which are the most effective at catalyzing WD. As shown in FIG. 5b, initial experimental results obtained using poly(phenylene oxide)-modified polymers containing phosphonate groups with pKₐ=7 indicate that WDF is improved both in the absence (at ˜0 V) and presence (>0 V) of electric fields enhancing WDF by an 10× over the state-of-the-art. Accordingly, in many aspects buffering groups such as, for example, phosphonates may be incorporated onto BPMs to catalyze WDF in solution, between pH=8.1 and pH=4. In various aspects these chemical functionalities are covalently bonded to polymer backbones. In the same or other aspects, polymers may also be modified with polar and/or charged groups to enhance hygroscopicity for enhanced hydration and water transport. While much of the data presented relates to PPO, it will be understood any polymer which is highly scalable, cost-effective, and that may be produced at large scales may be used according to aspects, such as, for example, poly(propylene oxide), polypropylene, and polyethylene. In certain aspects BPMs may be manufactured from monolithically cast polymers to enhance robustness. In such aspects the chemical modification may be performed from opposing directions using an H-cell. Moreover, membranes according to aspects of the disclosure may be interfaced to catalyst layers using fluorinated ionomers to mitigate degradation from water oxidation side reactions.

As previously summarized, studies performed (FIG. 5a) indicate that using two buffering groups can result in a synergistic enhancement of WDF that lessens the strict requirement of pKₐ≈7. Accordingly, in various aspects buffering groups may be used that span several units beyond 7. In the presence of significant electric-field-enhanced WD, pKₐ=3.5 buffering groups are particularly promising. To relax the constraint of a single buffering group with pKₐ≈7, various aspects of catalyzed BPMs co-modify polymers using two buffering groups with pKₐ≈7 (measured in solution). In some aspects metal-oxide nanomaterials, which are known to contain several protonatable groups, may be implemented. Aspects of BPMs using such nanomaterials can mitigate the risk associated with pKₐ values measured in solution changing when incorporated into polymers. Other aspects may incorporate electric-field enhancement of WD, which is mostly beneficial at large electric-field intensities often correlated with large overpotentials, which is not be deleterious to the dual-pathway system of the disclosure due to its weak reliance on voltage.

Monolithic membrane structures with covalently bound buffering groups according to aspects of the disclosure are inherently robust in comparison to the state-of-the-art and aid in the formation of atomically thin space-charge regions for maximum electric-field enhancement of WD. This allows for the use of these robust materials over extended periods of operation, which is critical to meet the FOA target of <$100/t-CO₂ in the long term.

Aspects of electrodialyzers according to the disclosure also implement cell and cell stack architectures to minimize polarization losses associated with WD at the BPM interface. In many electrodialyzers according to the disclosure stacks of various configuration may be employed to minimize polarization losses and allow for operation at high current densities. we will make advances in three areas. Cells and multi-cell stacks, may be optimized for channel width, flow rates and salt composition of input/output streams all of which depend highly on the operating current density. In various aspects such cell parameters are optimized for the lowest possible polarization loss. In many aspects continuum-level multiphysics modeling may be used to identify conditions that minimize polarization losses and optimize high current density stack operation. In various aspects 2D multi-physics simulation tools may be used to optimize the cell architectures for high current density operations. Such models may provide the optimal flow rates and cell dimensions which are dictated by the species concentrations, the target pHs and membrane properties at high current densities. For example, a high flow rate at the dilute salt channel (AEM/CEM) may be required in various aspects to minimize the resistive loss across that channel as Na⁺ and Cl⁻ ions start to deplete and increase the cell resistance.

### Aspects of an Acidic Pathway

As previously discussed with respect to FIGS. 1a/1b and FIG. 2, in various aspects the dual-pathway system implement an acidic pathway comprising a source of screened oceanwater (116) (pH ˜8.1) in fluid communication with an acidification element (132) into which a source of HCl (128) is fed to acidify the oceanwater to a pH below the starting pH of ˜8.1. This acidified oceanwater (136) is then directed into a CO₂ extraction element (140), which for the acidic pathway is a suitable catalyst-bonded membrane contactor. This membrane contactor then produces a flow of gaseous CO₂, which may be extracted via a vacuum pump or other suitable apparatus and directed to post extraction storage or processing as a feedstock, and a flow of decarbonized acidified oceanwater, which is mixed with a flow of alkaline oceanwater and returned to the ocean.

Although methods of extracting CO from a feedstock of acidified oceanwater are known, currently acidified oceanwater with pH=4 is required to help drive gaseous CO₂ removal. In these conventional systems, a high surface area gas stripping unit is required to efficiently produce gaseous CO₂ from oceanwater, by decreasing diffusional mass transport limits for dissolved CO₂ whose concentration is only ˜2 mM in acidified oceanwater. However, this requires that oceanwater, which has an approximate pH 8.1, be first acidified to pH=4 in order to increase rates for interconversion of bicarbonate and CO₂ so that it does not limit the rate of gaseous CO₂ removal from membrane contactors, which are often used to strip gaseous CO₂ from oceanwater. The problem arises that, by only using acid generated by the electrodialyzer to adjust the pH to ˜4, required for effective use of state-of-the-art gas stripping units for oceanic CO₂ removal, it is not possible to meet the long term i-CO₂/yr to meet the long-term cost target of <$100/t-CO₂. This is because in such a system the majority of the energy required in system is used to power the electrodialyzer unit to create the necessary pH swings.

Accordingly, aspects of the dual-pathway system decrease the required volume of acid/base needed for oceanic CO₂ removal by implementing a membrane contactor for effective removal of CO₂ from pH ˜4 to pH ˜7 oceanwater in the acidic pathway. As a result, the vast majority of the processed oceanwater needs only to be pumped a short vertical distance from underneath the floating platform, followed by an addition of small amounts of HCl to drive CO₂ removal from rather high-pH oceanwater (pH=4 to 7) in the catalyst-containing gas-liquid contactor within the acidic pathway, thereby improving the overall system efficiency.

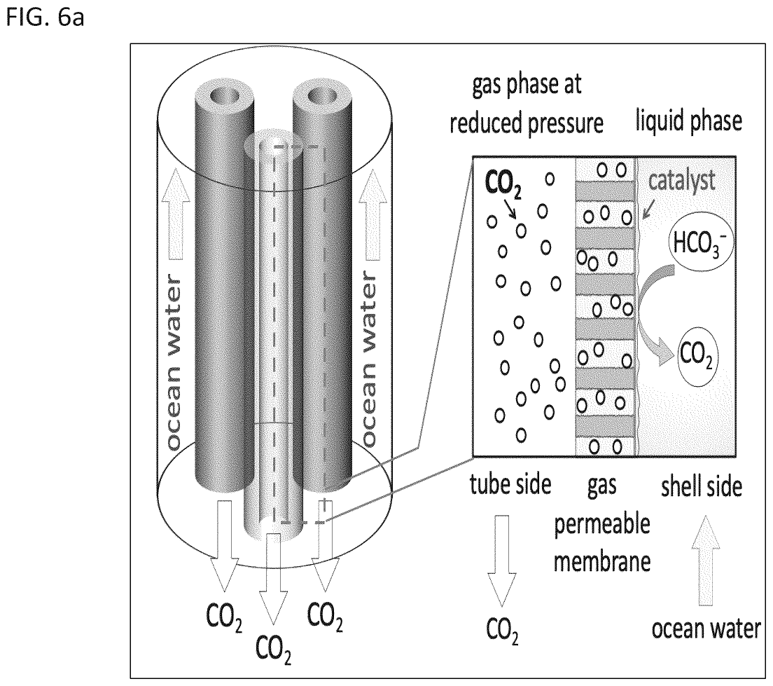

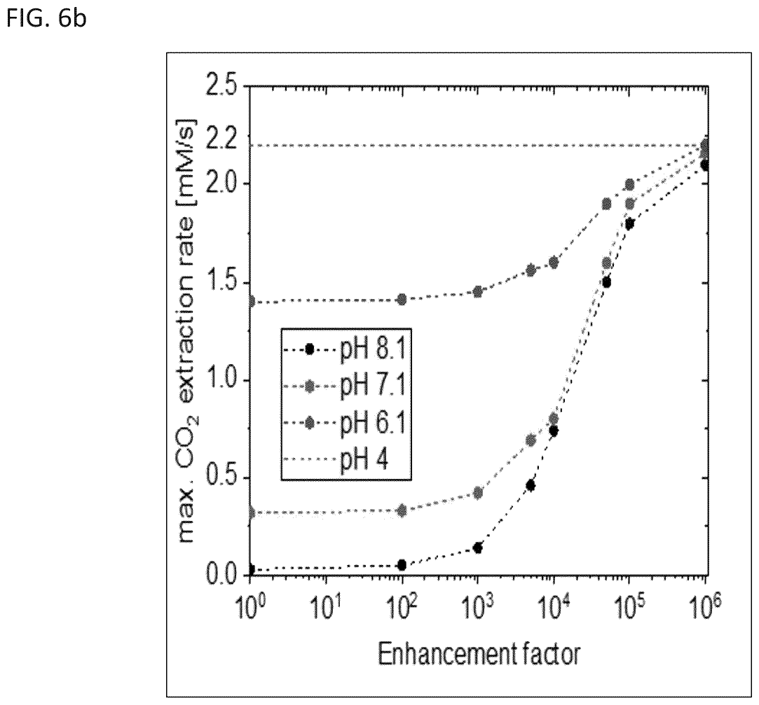

Specifically, in various aspects of the disclosure atom-efficient tailored catalysts are bound to gas-liquid membrane contactor materials (FIG. 6a) leading to significantly increase rates for interconversion of bicarbonate and CO₂. Specifically, in various aspects a membrane contactor operating at pH˜4 to ˜7 for effective oceanwater CO₂ is provided via the use of WDF catalysts and bicarbonate dehydration and formation (BDF) catalysts as synthetic carbon anhydrase mimics to significantly accelerate the inherently sluggish rates for interconversion of bicarbonate and CO₂. In some such aspects gas-liquid membrane contactors using catalyst-bonded hollow fiber membrane bundles (FIG. 6a) may be implemented. In aspects incorporating such catalyst-bonded hollow fiber membrane bundles, the spatial location of catalysts, flow rates of acidified oceanwater in hollow fiber materials, oceanwater pH and gas partial pressure in the membrane contactor are all relevant to the efficiency of the overall system. In addition, CO₂ removal efficiency and mass transport in the bundled fiber materials are factors.

Accordingly, in many aspects chemical grafting or mixing with typical membrane/fiber materials, such as, for example, polypropylene hollow fibers, into the membrane contactor may be used to incorporate catalyst buffering groups (as described above) at the shell side of the fiber materials. Owing to the short diffusional distance in the membrane contactor and fast interconversion rate between bicarbonate and CO₂, the oceanwater may behave as a reservoir of dissolved CO₂ within the hollow membrane fiber material. In various aspects of the disclosure, hollow fiber modules in which microporous hollow fibers are woven into fabric bundles are implemented. In such implementations, catalyst layers may be coated at the shell-side of the fiber materials so that acidified oceanwater is in contact with catalysts of enhanced surface area compared to planar structures (as shown schematically in FIG. 6b, inset). While certain membrane and catalyst combinations are described above, it will be understood that other combinations may be employed according to aspects of the disclosure.

For example, in various aspects metal-oxide nanomaterial catalysts (which as previously discussed may be used to increase rates of water dissociation in BPMs in the acid-base generator) may also be added to membrane/fiber materials as composites to improve the rate of conversion in the BDF. Regeneration strategies including rapid pulse flushing using the dilute salt water and acid/base from the electrodialyzer stack and solar-thermal heating for reactivation of the membrane contactor may also be implements according to aspects of the disclosure to extend the lifetime of the catalyzed gas-liquid membrane contactor materials. In addition, while flows through the system are shown going only in line with the fiber bundles it will be understood that in some aspects baffles may be incorporated on the fiber exterior introducing flows counter to—and perpendicular to—the fibers optimizing gas-liquid contactor operation.

Regardless of the specific design, catalyst-coated membrane materials according to aspects of the disclosure enhance rates for interconversion of bicarbonate and CO₂. As a result, instead of pH≈4, a much higher pH (pH 4 to 7) can be used to efficiently remove CO₂ from oceanwater, even with small reduced pressure gas flow streams. As shown in FIG. 6b, enhancing the rates of the forward and reverse reactions for interconversion of bicarbonate and CO₂ by a factor of 10⁶, in accordance with aspects of the disclosure, yields maximum CO₂ removal rates at pH values of 6.1, 7.1, or even 8.1 (native oceanwater) similar to oceanwater at the conventional threshold of pH=4. In turn, efficient removal of CO₂ from high pH oceanwater (pH >4 to >7) requires much less acid and base to be produced by the electrodialyzer. For instance, using oceanwater at pH=7.1, only 1/360^{th} of the oceanwater needs to be pre-treated, which will significantly lower electrodialyzer costs. In various aspects of the dual-pathway system, ˜0.5% of the incoming water volume needs to be converted to acid/base, and with moderate concentration (<0.5 M); and this requires pre-treatment of ˜0.5% of the total processed oceanwater for use in the electrodialyzer stack. Moreover, as previously discussed with respect to FIG. 1b, in various aspects the acid-base generator may be configured to recycle the dilute effluent from the electrodialyzer back into the electrodialyzer such that an even smaller proportion of oceanwater must be pre-treated, thus further reducing the overall energy input needed to run the electrodialyzer system.

Turning to the buffering catalysts themselves, it will be understood that aspects of the disclosure contemplate various buffering groups, whose pKₐ values span ˜3.5-10.0 and over a variety of concentrations and pH conditions, and for 1-3 buffering group combinations which are shown to relax pKₐ constraints to achieve rapid rates of WDF (FIG. 5a). Analyzing the kinetics of how CO₂ is released from a small-volume aqueous solution containing bicarbonate and different buffering groups may be used to identify specific species. This allows for the identification of optimal combinations in terms of tradeoff in stability and effectiveness in solution, followed by optimization when covalently bound to ionomer and small polymer groups that are soluble in water, and ultimately when covalently incorporated into ion-exchange membranes and gas-liquid membrane contactors. Polymer polarity may also be tuned via chemical modification to enable specificity for CO₂ through variations in equilibrium constant for absorbing CO₂ from oceanwater, such that moderate binding strengths are attained allowing for the speed up conversion of dissolved CO₂ into gaseous CO₂ under minimal vacuum or flow conditions.

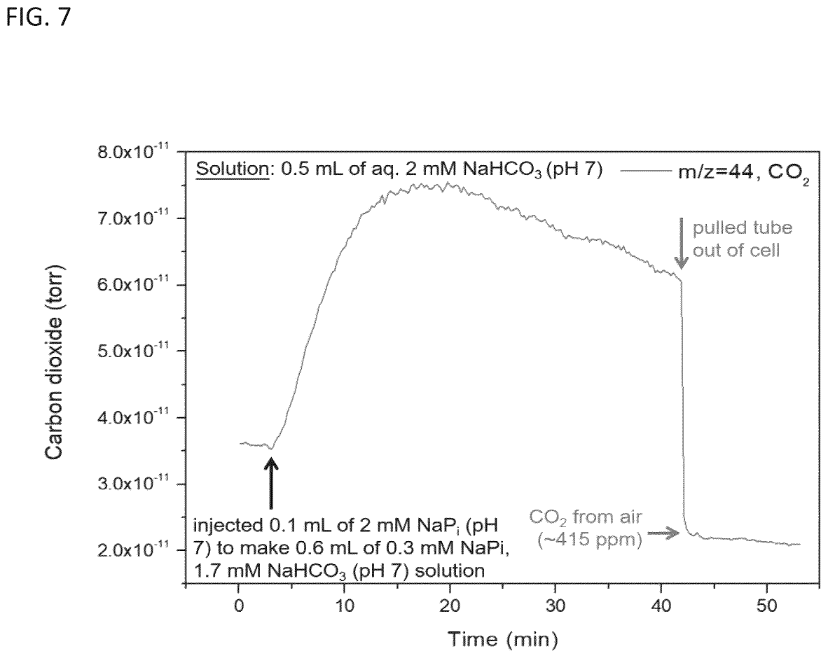

In various aspects, the inherently slow rate of CO₂ dissolution to form bicarbonate may be overcome using carbonic anhydrase, one of the most effective known biological catalysts of any reaction, with a catalytic rate enhancement on the order of 10⁷. This reaction proceeds via a hydroxylated intermediate that ultimately transfers OH⁻ to CO₂ via a rate-limiting step of WD. Because catalysts increase the rate of forward and reverse reactions, aspects of such a carbonic anhydrase system are used to enhance rates of oceanic CO₂ removal according to the disclosure. Models indicate that buffering groups with pKₐ=7 exhibit the most rapid catalysis of WDF, the active site of carbonic anhydrase contains a Zn(II)-OH cofactor whose conjugate base has pKₐ≈6. Therefore, buffering groups—including metal cations like Zn(II)—and polymers developed for the WDF studies may be used for the catalysis of BDF according to aspects of the instant disclosure. FIG. 7 provides experimental results measuring CO₂ released from a 2 mM NaHCO₃ solution via inline mass spectrometry upon addition of a phosphate (pKₐ≈7, 2) WDF catalyst, according to aspects of the disclosure. As shown, catalyst systems according to aspects of the disclosure enhance the rate for interconversion of bicarbonate and CO₂ via BDF significantly even at the target pH of 4 to 7.

In addition, the use of a catalyzed BDF membrane, aspects of the system may incorporate other elements to enhance CO₂ release. For example, one issue that can arise is that the conversion of dissolved CO₂ into gaseous CO₂ may be slow. According to aspects of the disclosure, the BDF catalysts may be disposed at the gas/liquid interface via covalent bonding to polymers to help disrupt interfacial water hydrogen-bonding networks and decrease surface tension leading to increased gaseous CO₂ release. Moreover, catalytic rates for overall BDF may be further enhanced in aspects of the disclosure by increasing local temperature, which will also serve to lower CO₂ solubility. In aspects of many systems according to the disclosure high-efficiency photo-voltaics are utilized (see discussion of FIG. 2), in such systems infrared radiation may be transmitted through commercial bifacial solar cells and harvested by an infrared radiation absorbing photonic layer that can then be used to locally heat the membrane contactor to further facilitate CO₂ release.

In various aspects, as will be described in greater detail below the gaseous CO₂ captured from the gas-liquid contactor may be used as a feedstock in various industrial processes thereby increasing the economic benefits of the system. However, flows of CO₂ captured from the gas-liquid contactor may contain other impurities such as H₂O, O₂, and N₂, and depending on the pH swing required for effective CO₂ release, even small amounts of HCl due to the high concentration of Cl⁻ in oceanwater. To separate dissolved gases besides CO₂, aspects of the membrane contactor may be configured such that no catalyst buffering groups exist near its inlet, thus initially resulting in rapid O₂ and N₂ release. By first flowing oceanwater through regions of the membrane contactor that do not contain BDF catalysts, O₂ can be purged, such that in subsequent catalyst-containing regions, CO₂ release will mostly only be accompanied by water vapor generation. Downstream of the catalyst-free region the acidified degassed oceanwater will then encounter a buffer-catalyst-coated region, facilitating release of CO₂ as well as H₂O and HCl impurities. In various aspects these remaining impurities may be separated using moderate swings in temperature and/or pressure at a centralized location. Ultimately, impurities will be reintroduced to the flow stream, plus addition of alkaline oceanwater, so that the effluent is only decarbonized oceanwater, as shown and described in relation to FIGS. 1a/1b. In addition, in various aspects membrane anti-fouling and subsequent decontamination may be performing using periodic gas purging processes and/or addition of excess acid/base to prolong the duty cycle of the BDF membranes.

### Aspects of the Alkaline Pathway

As described above and shown in FIG. 1a, in various aspects the dual-pathway system, according to embodiments, further comprises an alkaline pathway (106) wherein an incoming flow of screened oceanwater is flowed through a basification element (138) in which a feedstock of NaOH (130) produced in the acid-base-generator (102) is introduced to raise the pH of the incoming oceanwater from ˜8.1 to ˜10. The basified water feedstock (138) is then introduced into a sedimentation element (146) wherein precipitation products are collected. The remaining alkaline water is then recombined with the acidic water such that a natural pH water effluent of ˜8.1 is reintroduced into the environment.

The transformation of CO₂ into a precipitated mineral carbonate through a mineral carbonation route is considered a promising option for carbon capture and storage (CCS) since the captured CO₂ can be stored permanently. Aspects of the disclosure incorporate this process into the alkaline pathway of the dual-pathway system.

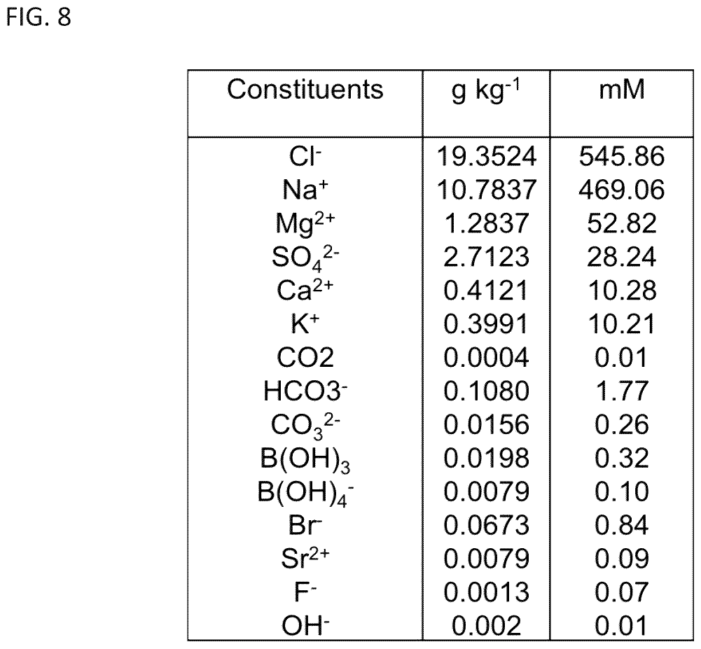

Possible precipitation products from oceanwater mineral carbonate precipitation reactions, including CaCO₃, Ca(OH)₂, MgCO₃, Mg(OH)₂, SrSO₄, CaF₂ and CaSO₄ are all incorporated into aspects as these different precipitates may be accessed at different temperatures, pHs and salinities. FIG. 8 includes the major ions and their relevant concentrations in the oceanwater showing the availability of ions in oceanwater for the various precipitation reactions.

In configuring the alkaline pathway according to aspects of the disclosure, the water dissociation reaction kinetics, CO₂/bicarbonate/carbonate acid base reactions and their reaction rates, as well as the boric acid reactions in oceanwater are considered. For example, the following two reactions may be used to describe the CO₂/bicarbonate equilibrium:

$${CO}_{2} + {H}_{2} O {{⇄}_{{k}_{1 -}}}^{{k}_{1 +}} {H}^{+} + {HCO}_{3}^{-} \qquad ( EQ . 3 )$$

$${CO}_{2} + {OH}^{-} {{⇄}_{{k}_{2 -}}}^{{k}_{2 +}} {HCO}_{3}^{-} \qquad ( EQ . 4 )$$

with k_{f} and k_{b} representing the forward and backward rate constant, respectively, for each reaction. The temperature and salinity dependence of all equilibrium constants also needs to be considered. For example, the K_{w} for water dissociation follows:²

$$ln {K}_{W} = 148.96502 - \frac{13847.26}{T} - 23.6521 ln T + ( \frac{118.67}{T} - 5.977 + 1.0495 ln T ) \sqrt{S} - 0.01615 S \qquad ( EQ . 5 )$$

where T is the oceanwater temperature and S is the oceanwater salinity. Using such calculations, it is possible to determine and thus control the preferential precipitates when the pH of the basified stream is changed from 8.1 to 12 with oceanwater at different temperature and salinity. As for the precipitation, calculated and experimentally measured rate constants for growth and nucleation as well as supersaturation ratio and induction time for nucleation may also be considered to predict various precipitation products.

An understanding of the kinetics of the various precipitation products from oceanwater is important because while adjustments could be made to favor the production of most of them, not all of them lead to the same level of efficiency in CO₂ capture. For example, an important feature of calcium carbonate precipitation is the polymorphicity of the product. While the formation of mixtures of rhombic calcite and spherical vaterite, and the needlelike aragonite have been reported under various experimental conditions, for the purpose of CO₂ capture and extraction in the form of solid precipitates, these precipitation products will work equally well as long as the precipitation kinetics are fast enough to achieve high capture efficiency with the given flow rate of oceanwater. On the other hand, other precipitation products, in particular, Mg(OH)₂ with a very low Ksp of 1.8×10⁻¹¹, if preferentially precipitated, will consume hydroxide ions in the basified stream that were produced from the bipolar membrane based electrodialzyer, hence lowering the overall energy efficiency and raising cost for CO₂ capture from oceanwater.

Accordingly, aspects of the disclosure are directed to operational relevant conditions to optimize calcite crystal formation. According to various aspects of the disclosure the pH of the basified water is made to be ˜10 to 11 to most efficiently access CaCO₃ precipitates. This may be counter-intuitive as increasing the pH of the basified stream above a pH of ˜10 would increase the concentration of the carbonate ions for CaCO₃ precipitation, but at the same time, it also increase the formation of Mg(OH)₂. Accordingly, aspects of the invention incorporate thermodynamic calculations in the above-mentioned model such that an optimal pH range for preferential CaCO₃ precipitation (e.g., ˜pH 10 to 11) is implemented within the basification element.

Aspects of the alkaline pathway may also incorporated seeded crystal growth to control precipitation of CaCO₃. Given the nature of oceanwater processing at a large scale, homogeneous seeding using molecular or polymeric additives are not feasible unless those seeds can be re-used. In various aspects of the disclosure, CaCO₃ seeds, such as vaterite or calcite crystals or relatively concentrated salt solutions derived from them, all of which will be produced within the hybrid system, to accelerate the rate of overall CaCO₃ precipitation may be implemented. Other heterogeneous seeding methods may also be implemented according to aspects, such as using fine mesh and pointed substrates. Small quantities of dissolved organic matter present in natural oceanwater may also have an effect on the kinetics of CaCO₃ precipitation for CO₂ capture and thus strategies to optimize the presence or absence of such organic matter may also be implemented. In summary, by controlling the pH, temperature and various seeding strategies in aspects of the dual-pathway system, the kinetics for CaCO₃ precipitation and energy efficiency for CO₂ capture in the basified stream may be optimized.

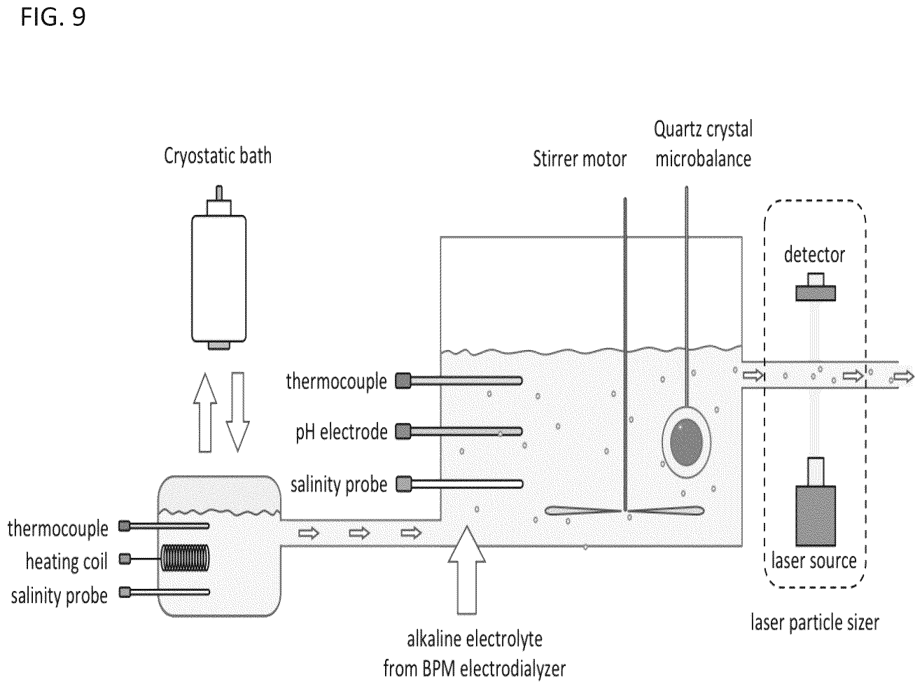

Quantitative characterization of the solid precipitation kinetics in the basified stream, according to aspects of the disclosure may be determined using an apparatus such as that provided in FIG. 9. As shown, in the device electrochemical quartz crystal microbalance measurements will be used for real-time monitoring of precipitation kinetics. In-line particle sizer may also be used to monitor the formation of suspended precipitates in the basified stream in real time. In addition, the temperature, pH and salinity of the basified stream both in the reactant chamber and the reaction chamber may be continuously monitored by thermometry, pH monitoring and salinity measurements, respectively, while SEM and EDX may be used to further analyze the chemical composition of the precipitation products.

In addition to this carbonate precipitate pathway, as discussed with respect to FIG. 1b, in various other aspects of dual-pathway systems, the alkaline pathway may use a gas feedstock that incorporates a direct air capture system that captures CO₂ from the gas feedstream using an aqueous solution with ionic concentrations of roughly 1.0 M OH⁻, 0.5 M CO₃²⁻, and 2.0 M Na+. In such aspects the alkaline pathway produces an output stream of CO₂ lean gas and a carbonate solution. The configuration of the direct air capture system may take any suitable form, but in various aspects it may comprise a contactor that brings feedstock gas in contact with the alkali capture solution. Capture of CO₂ from the feedstock gas occurs at the surface of the solution, and any suitable structure may be used to increase the contact area, e.g., by flowing the gas feedstock and solution together across a high surface area element. It will be understood that aspects may include any suitable contactor design.

### Economic Aspects of a Dual-Pathway System

According to aspects of the disclosure an off-shore, stand-alone system for efficient and cost-competitive removal of CO₂ from oceanwater is provided. Three specific aspects of the system significantly lower the cost for CO₂ removal, as discussed in the sections above: i) co-location on or near a body of salt water; ii) a low-overpotential electrodialyzer that operates at high current densities (between 250 mA/cm² to >1000 mA/cm²), and iii) a novel membrane contactor that exhibits unprecedented rates for CO₂ removal from only slightly acidified oceanwater (pH≈4 to 7). These aspects minimize energy devoted to: i) water pumping; ii) salt-splitting, in which ˜0.5% of the water volume is converted to acid/base, and with moderate concentration (<0.5 M); and iii) water pre-treatment of ˜0.5% of the total processed oceanwater for use in the electrodialyzer stack. Application of such the dual-pathway system enables the process to meet the <$100/t-CO₂ cost target at a projected scale of Gt-CO₂/yr. Aspects of the design also achieve an unprecedented second law efficiency of 50% (or 0.46 MWh/t-CO₂), and an estimated embodied emission of <2% of the lifecycle captured emissions. Moreover, aspects of the dual-pathway system are environmentally and ecologically friendly because acidification and subsequent basification of the oceanwater are performed in a closed system, so that the only effluent released back into the ocean is decarbonized oceanwater with the same salt level as at the intake.

Although specific embodiments of the invention have been described and illustrated, the invention is not to be limited to the specific forms or arrangements of parts so described and illustrated. The scope of the invention is to be defined by the claims appended hereto and their equivalents.

Although the operations of the method(s) herein are shown and described in a particular order, the order of the operations of each method may be altered so that certain operations may be performed in an inverse order or so that certain operations may be performed, at least in part, concurrently with other operations. Instructions or sub-operations of distinct operations may be implemented in an intermittent and/or alternating manner.

It should also be noted that at least some of the operations for the methods described herein may be implemented using software instructions stored on a computer usable storage medium for execution by a computer. As an example, an embodiment of a computer program product includes a computer usable storage medium to store a computer readable program.

The computer-usable or computer-readable storage medium can be an electronic, magnetic, optical, electromagnetic, infrared, or semiconductor system (or apparatus or device). Examples of non-transitory computer-usable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

What is claimed is:

1. A dual-pathway system for CO₂ capture comprising:
a platform disposed adjacent a source of oceanwater;
an acid-base-generator in fluid communication with the source of oceanwater comprising:
a purification apparatus configured to convert a first portion of the oceanwater into a feedstock of NaCl, and
at least one electrodialyzer in fluid communication with the purification apparatus and incorporated a bipolar membrane configured to convert the feedstock of NaCl into a HCl feedstock and a NaOH feedstock;
an acidic CO₂ removal system in fluid communication with the source of oceanwater comprising:
an acidification element in fluid communication with the HCl feedstock and configured to produce an acidified oceanwater feedstock from the oceanwater, and
a catalyst-bonded membrane contactor in fluid communication with the acidification element and a vacuum system to extract gaseous CO₂ from the acidified oceanwater feedstock and output a decarbonized acidified oceanwater effluent to an output;
an alkaline CO₂ removal system in fluid communication with a source of fluid entrained CO₂ and in further fluid communication with the NaOH feedstock and configured to produce a CO₂ lean effluent and a carbonate; and
wherein the output mixes the decarbonized acidified oceanwater effluent and at least one effluent from the alkaline CO₂ removal system to form a mixed oceanwater effluent for release into the environment.

2. The dual-pathway system for CO₂ capture of claim 1, wherein the alkaline CO₂ removal system is in fluid communication with the source of oceanwater and comprises:
a basification element in fluid communication with the NaOH feedstock and configured to produce a basified oceanwater feedstock from the oceanwater, and
a sedimentation element in fluid communication with the basification element to collect mineral carbonate precipitates from the basified oceanwater feedstock and output a decarbonized basified oceanwater effluent to the output; and
wherein the output mixes the decarbonized acidified oceanwater effluent and the decarbonized basified oceanwater effluent to form a mixed oceanwater effluent having a pH approximately equivalent to the pH of the source of oceanwater for release into the environment.

3. The dual-pathway system for CO₂ capture of claim 1, wherein the alkaline CO₂ removal system is in fluid communication with the fluid entrained CO₂, which comprises a source of CO₂ containing gas feedstock and comprises:
a direct air capture element in fluid communication with the NaOH feedstock and the CO₂ containing gas feedstock configured to produce a CO₂-lean gas effluent and a carbonate solution; and
wherein the output mixes the decarbonized acidified oceanwater effluent and the carbonate solution to entrain the CO₂ within the carbonate into the decarbonized acidified oceanwater effluent for release into the environment.

4. The dual-pathway system for CO₂ capture of claim 1, wherein the acidified oceanwater feedstock has a pH range between pH˜4 to pH˜7.

5. The dual-pathway system for CO₂ capture of claim 2, wherein the basified oceanwater feedstock has a pH of around 10, and wherein the mineral carbonate is CaCO₃.

6. The dual-pathway system for CO₂ capture of claim 2, wherein the oceanwater and mixed oceanwater effluent have a pH of around 8.

7. The dual-pathway system for CO₂ capture of claim 1, further comprising at least one pre-processing element disposed between the source of oceanwater and the acid-base generator, the acidic CO₂ removal system and the alkaline CO₂ removal system to screen the oceanwater.

8. The dual-pathway system for CO₂ capture of claim 7, wherein the pre-processing element comprises a drum-screen filter.

9. The dual-pathway system for CO₂ capture of claim 1, wherein the purification apparatus comprises one or more of the elements selected from the group consisting of dissolved air flotation clarifiers, micro/ultra-filters, cartridge filters, and water softening ion exchangers.

10. The dual-pathway system for CO₂ capture of claim 9, wherein the purification apparatus comprises at least a clarifier and an ion exchanger, and wherein the clarifier is in fluid communication with the HCl feedstock and the ion exchange is in fluid communicate with the NaOH feedstock.

11. The dual-pathway system for CO₂ capture of claim 1, wherein the electrodialyzer is configures to operate at a current density between 250 mA/cm² to 1000 mA/cm².

12. The dual-pathway system for CO₂ capture of claim 1, wherein the bipolar membrane comprises a catalyzed ionic layer bound directly onto one of either a cationic-exchange membrane or an anionic-exchange membrane.

13. The dual-pathway system for CO₂ capture of claim 12, wherein the ionic layer has a thickness between 5-50 μm.

14. The dual-pathway system for CO₂ capture of claim 12, wherein the bipolar membrane is a trilayer structure comprising at least three elements selected from the group consisting of porous solid electrolytes, cationic-exchange membranes, and anionic-exchange membranes.

15. The dual-pathway system for CO₂ capture of claim 12, wherein the catalyzed ionic layer comprises at least one buffering group with a pKₐ of approximately 7.

16. The dual-pathway system for CO₂ capture of claim 15, wherein the catalyzed ionic layer comprises at least one buffering group covalently bound to a polymer backbone.

17. The dual-pathway system for CO₂ capture of claim 16, wherein the polymer backbone is selected from the group consisting of polyethylene oxide, polypropylene and polyethylene.

18. The dual-pathway system for CO₂ capture of claim 16, wherein the at least one buffering group is selected from the group consisting of phosphonates and metal-oxide nanomaterials.

19. The dual-pathway system for CO₂ capture of claim 1, comprise a stack of electrodialyzers.

20. The dual-pathway system for CO₂ capture of claim 1, wherein the catalyst-bonded membrane contactor comprises one or more gas-liquid membrane contactor materials having bonded thereto a buffering group catalyst.

21. The dual-pathway system for CO₂ capture of claim 20, wherein the gas-liquid membrane contactor material comprises one or more hollow-fiber.

22. The dual-pathway system for CO₂ capture of claim 21, wherein the one or more hollow-fiber is a material selected from the group consisting of polypropylene or polyethylene.

23. The dual-pathway system for CO₂ capture of claim 20, wherein the buffering group catalyst is a synthetic carbon anhydrase mimic.

24. The dual-pathway system for CO₂ capture of claim 21, wherein the catalyst-bonded membrane contactor comprises a baffle structure disposed exterior to the one or more hollow-fiber such that flows of the acidified oceanwater feedstock are introduced at one or more angles to the one or more hollow-fiber.

25. The dual-pathway system for CO₂ capture of claim 20, wherein at least a portion of the catalyst-bonded membrane contactor proximal to an intake thereof is free of the buffering group catalyst.

26. The dual-pathway system for CO₂ capture of claim 1, further comprising one or more renewable power sources electrically interconnected to power the dual-path system.

27. The dual-pathway system for CO₂ capture of claim 26, wherein at least one of the renewable power sources if photovoltaics and wherein the photovoltaics collect infrared radiation, and wherein the infrared radiation is used to generate heat to heat the catalyst-bonded membrane contactor.

28. The dual-pathway system for CO₂ capture of claim 2, wherein the sedimentation element is further provided with at least one seeding growth material selected from the group consisting of vaterite, calcite, and salt solutions thereof.

29. The dual-pathway system for CO₂ capture of claim 1, wherein the first portion comprises ˜0.5% of the oceanwater introduced into the dual-pathway system.

30. The dual-pathway system for CO₂ capture of claim 1, wherein the catalyst-bonded membrane contactor is in fluid communication with the HCl feedstock.

31. The dual-pathway system for CO₂ capture of claim 1, wherein at least one electrodialyzer further outputs a dilute low salt concentration water effluent, and wherein the dilute low salt concentration water effluent is reintroduced into the electrodialyzer as a feedstock.

32. A dual-pathway method for CO₂ capture comprising:
introducing a first portion of oceanwater into an acid-base-generator;
converting the first portion of the oceanwater into a feedstock of NaCl;
electrodialyzing in a bipolar membrane the NaCl into a HCl feedstock and a NaOH feedstock;
introducing a second portion of oceanwater to an acidification element in fluid communication with the HCl feedstock to produce an acidified oceanwater feedstock from the oceanwater;
extracting gaseous CO₂ from the acidified oceanwater feedstock through a catalyst-bonded membrane contactor and outputting a decarbonized acidified oceanwater effluent;
introducing a source of fluid entrained CO₂ to an alkaline CO₂ removal system in fluid communication with the NaOH feedstock and configured to produce a CO₂ lean effluent and a carbonate; and
mixing the decarbonized acidified oceanwater effluent and at least one effluent from the alkaline CO₂ removal system to form a mixed oceanwater effluent for release into the environment.

33. The dual-pathway method for CO₂ capture of claim 32, wherein the source of fluid entrained CO₂ comprises a third portion of oceanwater, and further comprising:
introducing the third portion to a basification element in fluid communication with the NaOH feedstock to produce a basified oceanwater feedstock from the oceanwater;
collecting a mineral carbonate precipitate from the basified oceanwater feedstock and outputting a decarbonized basified oceanwater effluent; and
mixing the decarbonized acidified oceanwater effluent and the decarbonized basified oceanwater effluent to form a mixed oceanwater effluent having a pH approximately equivalent to the pH of the source of oceanwater for release into the environment.

34. The dual-pathway method for CO₂ capture of claim 32, wherein the source of fluid entrained CO₂ comprises a CO₂ containing gas feedstock, and further comprising:
introducing the CO₂ containing gas feedstock to a direct air capture element in fluid communication with the NaOH feedstock and configured to produce a CO₂-lean gas effluent and a carbonate solution; and
wherein the output mixes the decarbonized acidified oceanwater effluent and the carbonate solution to entrain the CO₂ within the carbonate into the decarbonized acidified oceanwater effluent for release into the environment.

35. The dual-pathway method for CO₂ capture of claim 32, wherein the acidified oceanwater feedstock has a pH range between pH˜4 to pH˜7.

36. The dual-pathway method for CO₂ capture of claim 33, wherein the basified oceanwater feedstock has a pH of around 10, and wherein the mineral carbonate precipitate is CaCO₃.

37. The dual-pathway method for CO₂ capture of claim 32, wherein the first portion comprises ˜0.5% of the oceanwater introduced into the dual-pathway system.
